(19) United States
(12) Patent Application Publication
(10) Pub. No.: US 2012/0246143 A1
(43) Pub. Date: Sep. 27, 2012

(54) METHOD FOR REDIRECTING A WEB BROWSER BASED ON THE KEYWORDS USED IN A SEARCH ENGINE

(76) Inventor: Lee Roberts, Noble, OK (US)

(21) Appl. No.: 13/430,392

(22) Filed: Mar. 26, 2012

Related U.S. Application Data
(60) Provisional application No. 61/467,093, filed on Mar. 24, 2011.

(51) Int. Cl. G06F 17/30

(52) U.S. Cl. 707/711; 707/706; 707/E17.108; 707/E17.083

(57) ABSTRACT

A method of responding to a request for web page includes the steps of receiving a request, extracting search query parameters from a request and redirecting to a mapped web page or alternatively responding with the requested web page. The search query parameters and requested web page are associated with each and stored for later processing and assignment.

### CLAIM OF PRIORITY

This application claims the benefit of U.S. Patent Application Ser. No. 61/467,093 filed on Mar. 24, 2011, entitled “Keyword Mapping Process,” the disclosure of which is hereby incorporated by reference.

### FIELD OF INVENTION

The invention generally relates to the field of keyword advertising on the internet.

### BACKGROUND OF INVENTION

Current search engine technology seeks to identify relevant web pages in response to an input of keywords (or search query) by users. Such search engines employ various processes and algorithms in an attempt to improve the relevancy of their results to a particular search query. Due to the quantity of web pages present on the internet, search engines automate a significant portion of the process of indexing and then ranking web pages in accordance with the search engine's algorithm.

Web site designers have developed a variety of techniques to improve the relevancy assigned to a particular web page by the search engine's automated processes. For web sites, these search engine optimization techniques are one aspect of a marketing strategy focused on “converting” user visits to actual purchases of services or products at a web site. User visits which do not convert, either because the visit did not result in a sale or in some other action desired by the web site (e.g., a user leaving their contact information), are often referred to as a “bounce.” Accordingly, marketing strategies that increase the number of conversions and decrease the number of bounces are desirable to web site owners.

One method of reducing the number of bounces is to ensure that users directed to a web site from a search engine are immediately presented with the most relevant page to their search query. Search engines typically present a list of relevant pages with a hyperlink to the page. When the user clicks on a hyperlink in the result list, the user's browser sends an “http header request” to the web server with authority to return the web page identified in the hyperlink. The web server responds to the http header request with the html code that comprises the requested web page. Web site owners have no direct control over what web pages are identified as the most relevant in response to a particular search query. There is, therefore, a need for a system that permits a web site owner to determine which web pages will be provided in response to a particular search query.

### SUMMARY OF INVENTION

The present invention provides a method for determining which web page is used to respond to a HTTP Header Request. The method permits a web server to redirect a browser to a mapped web page rather than responding with the web page initially requested by the browser, based upon the search query parameters generated in response to the keywords input by a user.

These and various other features as well as advantages which characterize the present invention will be apparent from a reading of the following detailed description and review of the associated drawings.

### BRIEF DESCRIPTION OF THE SEVERAL VIEWS OF THE DRAWING

FIG. 1 provides a flow chart depicting a preferred embodiment of the method for responding to an HTTP Header Request.

FIG. 2 provides a flow chart depicting the sub-process of associating a particular web page with a search query parameter.

FIG. 3 provides the interface used in the preferred embodiment to accomplish the sub-process depicted in FIG. 2.

### DETAILED DESCRIPTION OF PREFERRED EMBODIMENTS

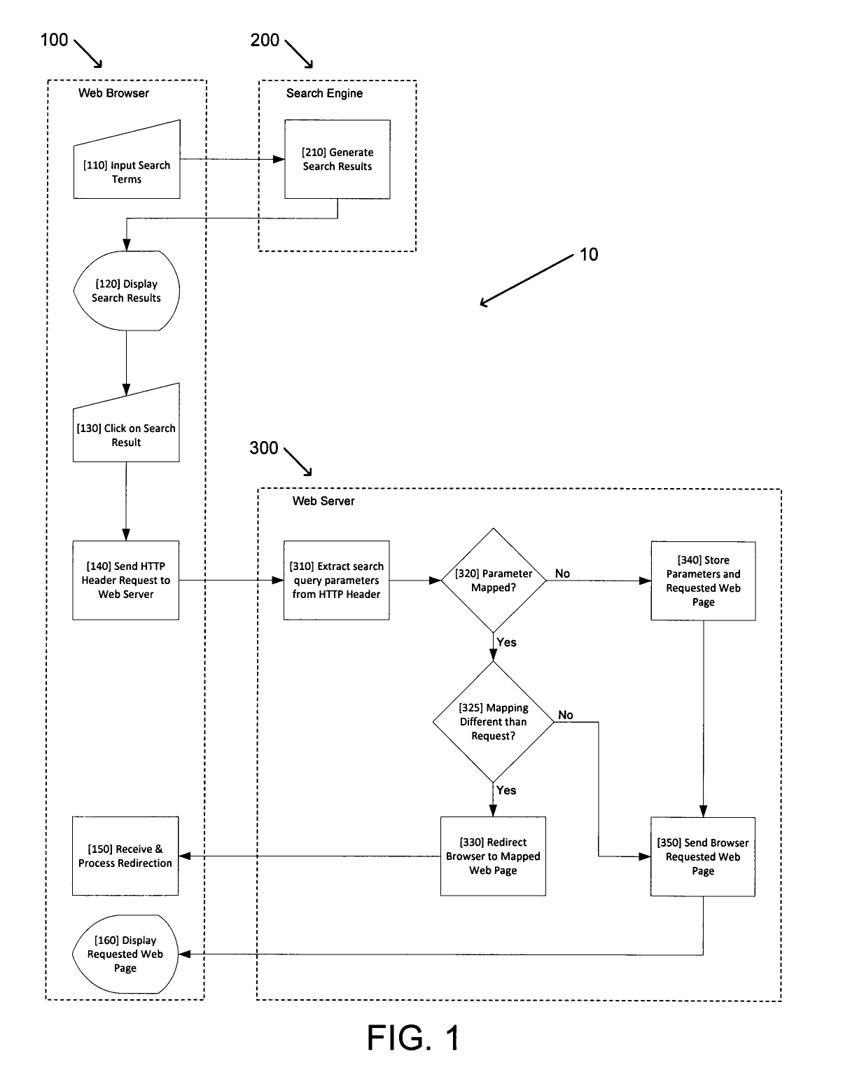

In order to provide a detailed description of various preferred embodiments of the present invention, reference is made to FIG. 1 which presents a functional diagram of the sub-processes involved in a process 10 of responding to a browser's request for a particular web page based upon the criteria previously entered into a search engine. The depicted process involves three major operative components, a web browser 100, a search engine 200 and a web server 300.

It will be understood that examples of the web browser 100 and search engine 200 are freely available for download and use via the internet. The web browser 100 is operated from a user device such as a personal computer, smart phone or other device capable of accessing the internet. Mozilla's Firefox, Microsoft's Internet Explorer and Apple's Safari are examples of software programs that can function as the web browser 100. Likewise, examples of a search engine 200 can be found at http://google.com and http://bing.com. The search engine 200 is typically located on a remote server and accessed through the internet. The preferred embodiment of the present invention will work with any web browser 100 and search engine 200 provided that such web browser 100 and search engine 200 perform the processes and functions described herein. The web server 300 is located on a local or hosted server and can be accessed by the browser via the internet.

It will be understood that the term “web server” used to describe component 300 is used in the most general sense, and refers to a component that can accept an HTTP Header Request and return a web page. Currently available web servers include the Apache web server and Microsoft's Internet Information Server.

FIG. 1 depicts a process for responding to a request from the web browser 100 for a web page with a mapped web page rather than the web page suggested by a search engine.

The process begins with step 110 wherein a user inputs one or more of search terms (commonly referred to as “keywords”) into a browser. The particular method used to input the keywords may differ based upon the particular web browser being used. For example, the web browser 100 may permit users to enter keywords directly into the address bar, or alternatively may require that the user navigate to the home page of the search engine 200 and enter the keywords directly into a text box on that home page. Regardless of the particular method used to input the keywords, step 110 is completed when the search engine 200 receives the keywords input by the user.

The search engine 200 then performs step 210. In step 210, the search engine 200 generates search results that are related to the keywords input in step 110. The search results may be formatted as a web page, as a series of web pages, or in another format requested by the web browser 100. Importantly, the search results include a plurality of search query parameters that identify the particular keywords input in step 110. The particular logic that the search engine 200 uses in determining which web pages are included in that list is typically proprietary, and specific to the search engine 200 that is employed in the process. Step 210 is completed when the search engine 200 returns the search results (with associated search query parameters) to the web browser 100.

The process continues with step 120 wherein the web browser 100 displays the search results. It will be understood that the search results, including any hyperlinks and search query parameters included in the search results, can be formatted in such a way that only a portion of the search results are displayed within the browser 120 at any given time. The search results are then typically displayed as a series of hyperlinked Uniform Resource Locators (“URLs”) that identify the address of a particular resource, usually a web page. Step 120 is completed when the search results are displayed by the web browser 100.

Step 130 is the next step in the process wherein the user chooses a particular search result that is displayed by the browser 100. This is often accomplished when the user clicks on one of the hyperlinks displayed within the web browser 100.

Once the user chooses a search result in step 130, the process continues to step 140 wherein the web browser 100 sends a HTTP Header Request to the appropriate web server 300. An HTTP Header Request includes a variety of header fields. A core set of header fields was standardized by the Internet Engineering Task Force in RFC 2616, and additional standard and non-standard fields are often included in each HTTP Header Request. One of the header fields in the core set is the Referrer String. The Referrer String typically includes the address of the web page generated in step 210, and includes the search query parameters that were generated by the search engine in step 210.

It will be understood that the identification of the appropriate web server can be accomplished through many different means, but is commonly accomplished by a Domain Name Service (DNS) lookup wherein the domain name portion of the hyperlinked URL is associated with a particular internet protocol address. Step 140 is completed when the Web Server 300 receives the HTTP Header Request.

In prior art web servers, the HTTP Header Request is received and the requested web page identified in the HTTP Header Request is then returned to the web browser.

In the present invention, however, the web server 300 does not always return the requested web page. Instead, the web server 300 includes an index of web pages that are associated with particular search query parameters (which may be keywords, tracking codes, or other parameters included in a header request). The web server 300 can then be configured to respond to the HTTP Header Request not with the requested web page, but rather with a different “mapped web page” that the web administrator has previously associated with the particular keywords searched by the user with the web browser (or other search query parameters). In this manner, the web server 300 can override the search results provided by the web server and respond to the HTTP Header Request with the mapped web page rather than the web page identified in the HTTP Header Request. The process of determining whether to redirect to a mapped web page in response to a particular HTTP Header Request is specifically depicted in steps 310 through 350.

Processing begins in step 310, wherein the web server 300 extracts the search query parameters from the HTTP Header Request sent from the web browser 100 in step 140. The web server 300 then further extracts the keywords, tracking codes or other parameters from the search query parameters.

Processing then continues to step 320, wherein the process determines if the parameters extracted in step 310 have been associated with a mapped web page. If the parameters have been associated with a mapped web page, then the web server 300 determines if the requested web page is different than the mapped web page in step 325. If the requested web page is different than the mapped web page, then the web server redirects the web browser 100 to the mapped web page in step 330. If the requested web page is the same as the mapped web page, then processing continues to step 350, where the web server 300 sends the web browser 100 the requested web page.

Turning back to step 320, if the web server 300 determines that the extracted parameters have has not been mapped, the web server 300 stores the parameters in step 340 and assigns a status of “unmapped” to the stored parameter and also stores the address of the webpage that was requested in the HTTP Header Request. The stored parameters can then be processed and mapped to a particular web page at some later date (as described below). In step 350, the web server 300 sends the web browser 100 the requested web page. The web browser 100 then displays the requested web page in step 160.

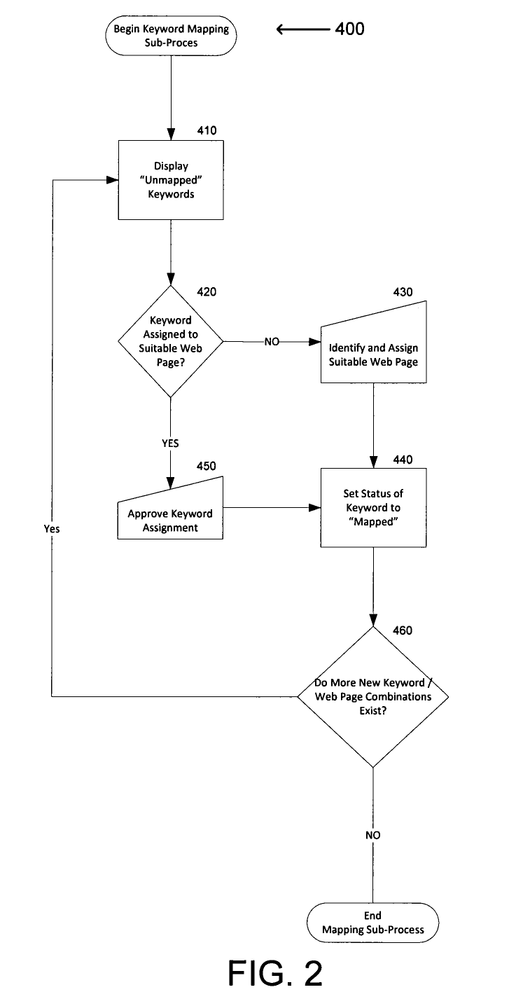

It will be understood that there are an infinite number of keywords that could be input by a user in step 110, and thereafter included in the HTTP Header Request sent in step 140. The web server 300 in the preferred embodiment is configured to store any keyword combinations that are not mapped to a particular web page for later processing in step 340. FIG. 2 depicts the process of mapping such stored keywords.

Turning to FIG. 2, therein depicted is the Keyword Mapping Administrative Sub-Process 400. The Keyword Mapping Administrative Sub-Process 400 may be initiated when convenient, and may run in parallel with the other sub-processes on the web server 300. Processing of the Keyword Mapping Administrative Sub-Process can occur within a personal computer or other device that has access to the web server 300. It begins with step 410 wherein the keywords with a status of “unmapped” are listed and displayed to the web site administrator along with the requested web page that was assigned to each keyword in step 340.

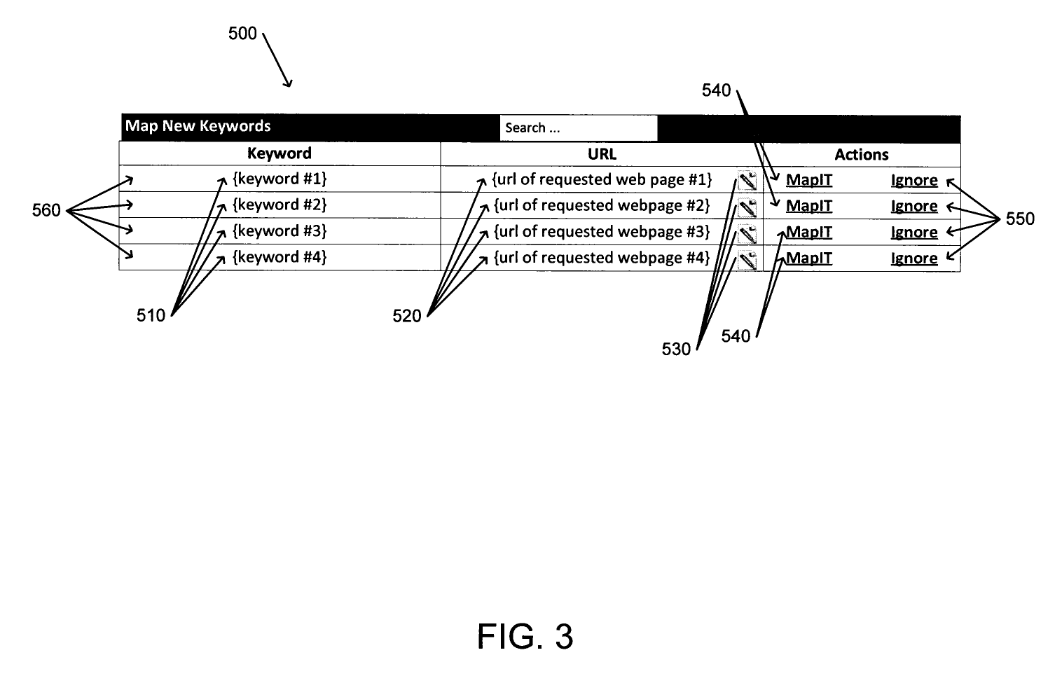

In the preferred embodiment, the stored keywords 510 are displayed in a table 500 next to the URL of the requested web page 520, as depicted in FIG. 3. As shown, each row 560 in the table 500 identifies a stored keyword 510, the URL of the requested web page 520, and an edit button or link (depicted as a pencil icon in FIG. 3) 530, a “MapIT” button or link 540, and an “ignore” button or link 550. While FIG. 3 depicts only four rows 560, the table 500 can include a greater or fewer number of keywords 510 and requested web pages 520, depending on the configuration of the system, display resolution of the device upon which the Keyword Mapping Administrative Sub-Process 400 is running, etc.

In step 420, the user reviews the list of displayed keywords and determines if the requested web page assigned to each keyword is suitable. If the administrator determines that the displayed association is suitable, then the administrator approves the keyword assignment in step 450. In the preferred embodiment, approval of a keyword assignment is accomplished by clicking on the “MapIT” link 540 at the end of row 560 of the association being approved. Alternatively, the administrator could determine that there is no current suitable page for a particular keyword. If the user so decides, then they may prefer to have that particular keyword exempted from future processing. In the preferred embodiment, the exemption of a keyword from future processing is accomplished by clicking on the “Ignore” link 550 at the end of the row 560 of the keyword 510 being exempted.

If the website administrator determines that the there is a different web page that should be mapped to a particular keyword, then in step 430 the administrator identifies the URL of that web page and overwrites the URL of the requested web page associated with the particular keyword. In the preferred embodiment, the URL for the requested web page is overwritten by deleting the URL 520 from the cell in the applicable row 560, entering the new URL of the desired web page and clicking the “MapIT” link 540.

Once a keyword has been approved or re-mapped, processing moves on to step 440 wherein the status of the keyword is set to “mapped.” In the preferred embodiment, step 440 is performed when the user hits the “MapIT” link.

After step 440 is performed, processing moves to step 460, wherein a determination is made if there are any additional keywords that have a status of “unmapped.” If there are, then processing returns to step 410, wherein the display of unmapped keywords is refreshed for the user to review. If there are no more “unmapped” keywords, then Keyword Processing Administrative SubProcess 400 terminates.

It is to be understood that while certain forms of this invention have been illustrated and described, it is not limited thereto, except in so far as such limitations are included in the following claims and allowable equivalents thereof.

It is claimed:

1. A method for responding to a request for a web page, wherein the request includes search query parameters, the method comprising the steps of:
creating an index of search query parameters associated with corresponding mapped web pages;
receiving the request for a web page;
extracting search query parameters from the request; and
responding to the request with a redirection to the mapped web page that corresponds to the search query parameters in the index.

2. The method of claim 1 wherein the request is sent by a web browser.

3. The method of claim 2 wherein the request is an HTTP Header Request.

4. The method of claim 3 wherein the mapped web page was previously associated with the search query parameters.

5. The method of claim 4 wherein the search query parameters were generated by a search engine.

6. The method of 4 wherein the search query parameters are keywords.

7. The method of claim 4 wherein the search query parameters are tracking codes.

8. The method of claim 6 wherein the keywords were entered by a user into the web browser.

9. A method for responding to a request for a requested web page, where the request includes search query parameters, the method comprising the steps of:
receiving the request for a web page;
extracting search query parameters from a request; and
responding to the request by redirecting to a mapped web page if the search query parameters are mapped to the mapped web page and alternatively responding to the request with the requested web page if the search query parameters are not mapped to a mapped web page.

10. The method of claim 9 wherein the request is sent by a web browser.

11. The method of claim 10 wherein the request is an HTTP Header Request.

12. The method of claim 11 wherein the mapped web page was previously associated with the search query parameters.

13. The method of claim 12 wherein the search query parameters were generated by a search engine.

14. The method of claim 13 wherein the search query parameters are keywords.

15. The method of claim 14 wherein the keywords were entered by a user into the web browser.

16. The method of claim 13 wherein the search query parameters are tracking codes.

17. A method for re-assigning a plurality of search query parameters to a web page, the methods comprising the steps of:
storing the plurality of search query parameters;
assigning an unmapped status to each of the plurality of search query parameters;
associating the web page requested with each of the plurality of search query parameters;
displaying each of the plurality of search query parameters with its associated web page; and
selectively associating a different web page with each of the plurality of search query parameters and then assigning a mapped status to each of the plurality of search query parameters.

18. The method of claim 17, wherein the search query parameters are keywords.
